(19) United States
(12) Patent Application Publication
(10) Pub. No.: US 2003/0231186 A1
(43) Pub. Date: Dec. 18, 2003

(54) Method and system for electronic display of photographs

(76) Inventors: Robert W. Larson JR., Tinton Falls, NJ (US); Spencer Giacalone, Old Bridge, NJ (US)

Correspondence Address: Arthur M. Peslak, Esq., MANDEL & PESLAK, LLC, Suite 5, 80 Scenic Drive, Freehold, NJ, 07728, US

(21) Appl. No.: 10/174,381

(22) Filed: Jun. 17, 2002

(51) Int. Cl. G09G 5/00

(52) U.S. Cl. 345/619

(57) ABSTRACT

A visualization system for displaying and permitting the mixing, matching, combining, and manipulation of digital pictures related to a number of sources, vendors, and/or digital photograph owners (who may be clients of the system owner, and are hereafter referred to as clients) is disclosed. The pictures in the system, as well as some components of the system itself, offer color correction and/or color calibration, in order to permit users to ascertain the true relational/relative and/or absolute color of the item or items being viewed. The system provides manual and automatic methods for viewing individual digital photographs, and/or combined sets of digital photographs, from one or more angles. The system can provide a sense of movement in relation to items or combined sets of items, which remain combined even during movement and/or manipulation. The system can offer an enhanced sense of texture using high-density, digital photographs, along with overlaid and/or referential descriptive textual data, as well as other features that add visual detail. The system can integrate with other electronic systems, in order to provide a seamless electronic shopping experience. The system may offer users a number of other features, which may include, but not be limited to, creating stored lists of items, and viewing feedback and commentary from other users.

In order to boost business operation, the system can provide clients with product interest statistics, while enabling the invention owners and clients to control, manage, and approve account-related data, including, but not limited to user and/or group system authorization and authentication. Digital photograph owners can provide free-form descriptive text related to pictures, and/or choose descriptive text from a set of data types and variables. The system permits clients to authorize and benefit from the resale of rights to display digital photographs to other parties who are associated with the system. The system can gather, analyze, and present statistical data, from an entire chain of digital photograph owners and digital photograph (resale) buyers. The system can produce and display client billing data related to accounts.

### FIELD OF THE INVENTION

The present invention generally relates to a method and system for electronically displaying and viewing digital photographs, and more particularly to a method that permits users to combine, view, manipulate, and place one or more digital photographs into one or more virtual environments or scenarios. In addition, the system can permit digital photograph owners to control, administer, and resell digital photographs within the system while gathering statistical data on what digital photographs are being or have been viewed. The preferred embodiment of the present invention is directed to the particular application of selling related items of apparel.

### BACKGROUND OF THE INVENTION

There are a number of problems pertaining to the manner in which people learn, use their senses, and in particular, view objects within electronic systems, such as, but not limited to the Internet. These problems affect Internet shopping, online selling, online promoting, and many other uses of electronic systems. In general, these problems are related to an inequality between the ways electronic systems present information, and how humans experience and gather information in the real, physical world. The issues surrounding the electronic world can be broken down into more specific problems, which include a lack of realism, a lack of trust, and a lack of insight.

In the electronic world, there exists a lack of realism and human immersion, when compared to real “brick and mortar” store shopping. There are many things a user can do in a real environment that, until now, had no electronic equivalent. For instance, “web” users can't mix and match multi-dimensional digital photographs of items, and then view them, still in combination, from multiple viewpoints, nor can they normally get an adequate sense of texture—even though texture, combining items, and viewing from multiple angles, with depth and dimension is an integral part of shopping in a real store. Additionally, most digital systems are either too static and/or restrictive to provide most users with the sense of spontaneity, discovery, and flexibility that can be found in real stores, or too extravagant to provide utility and meaningful information with similar ease.

Unlike the real world, where objects can be experienced directly, using all human senses, user distrust is a major problem in electronic systems. Not only is the electronic realm generally limited to the single sense of sight, but there are often many different messages about the same subject in electronic systems, making some level of confusion and distrust almost inevitable. Additionally, because of the way the electronic systems work, subjects in digital photographs are likely to appear differently in the digital realm than they do in person, a fact that does not serve to build trust.

In a real store, meaningful sales and business data can be gathered in a number of ways. For example, in the physical world, it is easy to determine what establishments draw clients, and what drives the buying decisions of those clients, since staff can make in-person observations. In fact, in a real store, staff members can further deduce what items draw interest even when sales are not made. By passing this information back to suppliers, the entire chain of business, from producer, to distributor, to retailer can be influenced. Unfortunately, until now, the electronic world has only focused on gathering information pertaining to what sites (stores) draw clients, what files (or pages) are loaded in what quantity in a given time period, the personal information voluntarily provided by users, and what products they actually buy. Because very little information pertaining to pre and post sales is ascertained online, and it is difficult to move any of these types of data up an electronic supply chain, digital businesses are at a decision-making disadvantage.

Even when users are ready to further an electronic relationship, as, for example, when purchasing products, they often find that technical difficulties stand in their way. Electronic technical difficulties are a leading reason behind failed Internet sales and business relationships. Therefore, another main issue in the electronic world is presenting detailed, informative digital photographs and information without overcomplicating, limiting, impeding, or destroying the opportunity to continue online relationships.

### SUMMARY AND OBJECTS OF THE INVENTION

The present invention provides a system that is aimed at increasing the realism of electronic environments by enabling users to display, mix, match, combine, and manipulate digital pictures of many subjects, where this simultaneous display can originate from many disparate sources, all while presenting a consistent interface to gather additional, related information, and even initiate purchase of displayed items for sale. Thereafter, these pictures can be separated, if desired. The pictures in the system provide corrected relational coloration, and the system can provide tools to tune the user's display of color, in order to permit the viewer to ascertain reasonably accurate relational and/or absolute color of the objects being viewed, in effect creating a trustworthy visualization space for a plurality of clients. Additionally, the system provides its clients with a number of benefits, including the ability to gather statistical data, create pre-set catalogs of items for electronic distribution, restrict or otherwise contra-indicate the use and availability of specific photographs, and assign further detailed information that users can access in conjunction with the photographs.

In support of the present invention, the above method for visualizing digital photographs includes a number of objects. The first object of the invention provides for photographing at least one item in order to provide a compatible digital photograph and associated data set. Various descriptive pieces of information, which may incorporate, but not be limited to scaling data, descriptive text, coloration information, and alignment data, are associated with each digital photograph as part of an associated data set. The system adjusts digital photograph coloration based on a number of criteria, and the photographs and associated data are digitally stored. High quality, detailed, “close-up” digital photographs, which provide higher magnification without visual “pixilation” when being viewed, can be created and subsequently stored in relation to less detailed digital photographs. The system can create, and thereafter maintain, multiple views of each item, where the associated information for each digital photograph specifies data about the particular view.

After creating digital photographs and associated data, another object of the invention stores the digital photographs and corresponding information data set. This system permits both the system owner and the digital photograph client to authorize what actions certain users or groups of users may take when interacting with the system. This authorization may incorporate, but not be limited to, user and/or group authentication. As an example, the actions a certain client may take can include digital photograph viewing, enabling or disabling systems features, account management, digital photograph management, statistics report viewing, the addition, deletion and management of digital photograph related descriptive textual information, and more. The digital photograph storage object of this invention may permit the resale of rights to use digital photographs to other authorized users of the system. This object of the invention is also responsible for gathering digital photograph viewing statistics and interfacing with billing systems and/or computing and presenting billing information. Note that the database can gather and manipulate user-related data, including, but not limited to commentary, and reference lists, including, but not limited to “wish lists” and gift registries.

Once digitally stored, as per the present invention, digital photographs are treated as copyrighted property, where they can only be viewed using the system's proprietary electronic digital photograph viewer, which embodies the next object of the invention. The viewer is software that can inter-operate with commonly used “web browsers”, examples of which include, but are not limited to Netscape Navigator and Microsoft Internet Explorer. Note that the viewer is not limited to operation with web browsers, and can be made to work with other systems or applications. Along with many other functions, the viewer creates a graphical environment on the user's system in which digital photographs can be displayed, mixed, matched, combined and manipulated.

The viewer enforces the rules and controls, set out by the system owner and digital photograph client, on users. Digital photographs obtained, or accessed by any means other than use of the system's viewer will result in a distorted digital photograph or otherwise undecipherable files, thereby preserving the control of the distribution of each digital photograph within the invention's domain.

Digital photographs compatible with the viewer can be sourced from any server system, as long as the format, properties, and naming conventions established by the invention owner are followed and permission, in all its forms, as set out by the invention owner and/or digital photograph client, is granted. The viewer can enforce rules regarding acceptable source servers and/or systems. The viewer can function independently of any specific server system or web site, meaning specifically that it can maintain “state information” on behalf of a user regardless of moving from server system to server system. This allows digital photographs related to, or sourced from multiple clients, sites, servers, owners, and/or vendors to be viewed, potentially simultaneously and/or in combination, by the user, in the viewer at one time, and in one or more places.

When digital photographs are combined in the viewer, alignment data is used to control the compositing of digital photographs, automatically. The alignment data is pre-stored and associated with individual digital photographs in previous invention objects, not the display space. As an example of the usage of this alignment data, if the x/y human ankle position is pre-specified in digital photograph A as 200/300 and in digital photograph B as 250/350, the viewer automatically adjusts the origin position of the digital photographs in the final display so that the display position for each places the ankle at the same display coordinate, in this case A could have an origin of 50/50 and B an origin of 0/0 to line up the ankle. Note that this is a generic system, which can line up any other item set as it would shoes on feet.

If multiple views of items have been associated with any digital photograph (in previous invention objects), the user and/or the viewer may be able to change between the views of the item, manually and/or automatically. These additional views could potentially be used, in the viewer, in an unlimited number of ways, but a typical use would be for a series of digital photographs taken from equally spaced angles to permit the impression of turning an item, or set of combined items, moving around an item, or set of combined items, or having an item, or set of combined items, move in some way. Note that the system permits groups of combined items to be manipulated, at one time, while maintaining their realistic combination in the composited view. Additionally, the system permits individual items incorporated in a combination to be changed at any time during manipulation, movement, and/or rotation. Since alignment points are specified for all items and in all views, the display of combinations of compatible digital photographs can continue through multiple angles.

The system and/or the viewer may provide a tool which can color calibrate the user's display either manually or automatically. The processing of digital photos will be quality controlled to optimize color consistency from photo to photo, where that process may include color tuning based on reference color swatches embedded in each photo. Therefore, the system will offer digital photographs that show proper relational color to each other, with the potential to display proper relational color to a swatch or other reference photograph, and with the potential to present optimum coloration given the user's display.

The viewer can display textual information that was stored with digital photographs in previous invention objects. This function can be enhanced by using digital photograph-related coordinate points that specify what area of a digital photograph is relevant to each description, in order to relate item information to digital photographs using pointers or highlights, in the multiple views. For example, a description stating, “full-face helmet” can be shown with an arrow, highlight, marker, pointer, as an overlay, or by using some other reference relating the text to the helmet digital photograph. This description, and its referential markers would remain, and potentially remain related to the digital photograph, even when the item is manipulated in the viewer. Textual data can also be shown in relation to the display space, and not directly related to the photograph. Examples of this include, but are not limited to “drop down” information, menu driven textual data displays, and textual data located in other areas of the viewer object. The viewer can display user-related data, including, but not limited to, commentary, and reference lists, including, but not limited to “wish lists”, and distribute or aid in the distribution of such data on the user's behalf, for example emailing a list of suggested birthday gifts to friends and relatives.

The viewer can display highly detailed “close-up” digital photographs in relation to less detailed digital photographs. These digital photographs permit a high quality zoom feature. The system may permit users to specify the amount and quality of detail in the viewer's display of digital photographs, and, possibly, in the entire viewer object.

Within the viewer, background digital photographs can be varied in order to add dimensional, virtual context to the virtual environment, and to aid in the visualization of items. Background digital photographs can potentially come from any authorized source, including the user, with the understanding that color accuracy of outside-source photographs cannot be guaranteed. The background digital photograph can be assigned spatial information that defines scale as a function of position within the digital photograph. For example, a picture of a room could include information describing the shape/area of the floor in the picture to permit the viewer to compute digital photograph orientation, scale, and/or alignment for all points within that area. In that way, the viewer software can place digital photographs in the picture, while maintaining a realistic sense of depth, position, and dimension.

The viewer can also implement special display abilities for known types of objects to enhance the functionality of the system, generally with the aim of enhancing the realism of the virtual space. For example, a digital photograph of a wheel on a bicycle could be rotated to simulate motion or a simulated shadow cast by an object (simulated by the viewer software) could be varied to simulate variations in the virtual light source.

The viewer can maintain information for each digital photograph that links to or otherwise refers to another server system. This information can vary in detail, but in general may be used to add an item to a purchasing system on another server system, or to refer the user to another server system where more information can be obtained. In addition, the viewer might implement a “buy” function, in order to automate the purchase of products related to digital photographs displayed in the viewer. Referential information can potentially be specified by the invention owner or a client. Referential information specification is a function of digital photograph management, specified in previous objects of this invention.

The viewer will accept pre-stored combinations of digital photographs and/or alternative digital photographs, possibly allowing clients and users to pre-assemble suggested and/or favorite combinations. This information could be packaged as a quick link in a web page, in an “email” message, on storage media, some combination of these, or by other means.

The viewer can collect data about its use by the end user, for example but not limited to what digital photographs are viewed, for what duration, and in combination with which other digital photographs. The viewer can automatically send that data to the system, for statistical analysis, and reporting.

### BRIEF DESCRIPTION OF THE DRAWINGS

FIG. 1 Is a flow chart of overall method acts;

FIG. 2 is a schematic diagram of the present invention embodied as in a network system;

FIG. 3 is a flow chart of the photographic phase, including information and digital photograph construction;

FIG. 4 is a flow chart of the database operation phase;

FIG. 5 is a flow chart of viewer object invocation phase from a referring system;

FIG. 6 is a flow chart of viewer object invocation phase using pre-configuration from a referring application

FIG. 7 is a schematic diagram of the present invention embodied as an example of the viewer object;

FIG. 8 is a flow chart of viewer operation phase;

FIG. 9 is a schematic diagram representing the addition of items to an example of the viewer object;

FIG. 10 is a schematic diagram of combining items in an example of the viewer object

FIG. 11 is a schematic diagram of manually manipulating items in an example of the viewer object

FIG. 12 is a schematic diagram of automatically manipulating items in an example of the viewer object

FIG. 13 is a schematic diagram of showing an enlarged view of an item in an example of the viewer object.

FIG. 14 is a schematic diagram depicting an example of the viewer object making reference to, a system outside of the present invention.

### DETAILED DESCRIPTION OF THE INVENTION

The present invention will now be described in detail by reference to the presently preferred embodiment as illustrated in the attached drawings. However, as is well known to those of ordinary skill in the art, many obvious variations may be made to this embodiment without departing from the spirit or scope of the present invention as set forth in the claims.

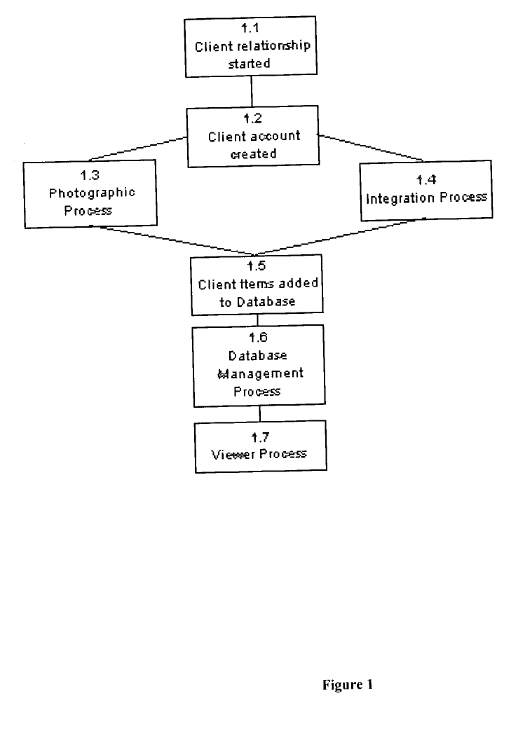

FIG. 1 is a flow chart of the general operation of the invention's objects including photography, database construction and viewing. The process of the present invention starts at block 1.1, in which the client (defined as the client of the system owner, and potentially a digital photograph owner or digital photograph buyer) relationship begins. Once the relationship begins, a client account with the system owner is created in block 1.2. Next, the photographic process begins (block 1.3), and potentially in parallel, the integration of the current invention with the client's system starts (block 1.4). After the photographic process, digital photographs are added to the present invention's database (block 1.5). Although potentially available earlier, the client may now manage digital photographs (along with their account) in the database system (block 1.6). After initial digital photograph management is completed, digital photographs are available to users, in the present inventions viewer process object (block 1.7).

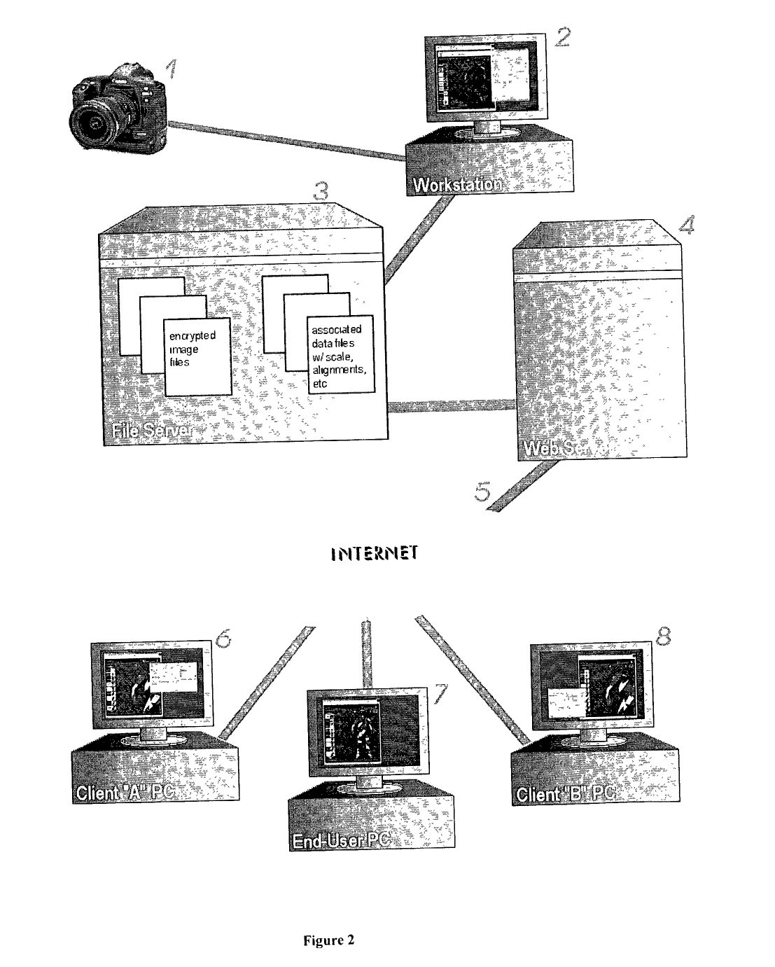

FIG. 2 illustrates the general operation of the present invention in a networked environment.

This figure illustrates the following flow:

(1-2) A digital camera 1 or alternatively a conventional film scanner (not shown in FIG. 2) is used to create image files that are sent to (generally via standard, PC communication port interface) and processed by the system owner's workstation 2. At the work station 2, photograph processing can include but is not limited to image color correction, image background removal, determination of alignment points and image scale, image encryption, and the creation of various resolution versions of an image. The photograph processing may be done by any combination of proprietary and commercially available software products.

(2-3) Image files and associated data files are transferred from the workstation 2 and stored on the system owner's file server 3;

(2-5-6) Notification is sent, via email, for example, to Client A at workstation 6 that digital photographs of their item(s) are available for their review, where availability of those image files for outside access (by end-users) is pending their approval.

(6-5-4-3) Client A accesses the server 3 via the workstation 6, and reviews and approves the new, digital images via an online interface provided by the system owner. Client A can also specify other, optional attributes for each approved image via this interface.

(7-5-4-3) An End-User 7 is able to access and view client-approved images. These images, which have been integrated into Client A's website according to the system owners' instructions, and appear to the end-user as if it is sourced from Client A's website. The client approved images are viewed via software provided over the internet by the system owner.

(8-5-4-3) In the event that clients may be granted control over redistribution of some images, where such control is made possible by various objects of the invention, Client B requests the use of a resale-able image from Client A via the workstation 8.

(3-5-6) The server 3 will then send Notification, via email for example, to Client A that Client B has requested to purchase the use of one or more of Client A's images, pending Client A's approval.

(6-5-4-3) Client A logs in to server 3, and approves the reuse of an image by Client B.

(3-5-8) Notification is sent from the server 3, via email for example, to Client B that Client A has approved the sale of the image.

(8-5-4-3) Client B logs in to server 3, and is able to specify their own attributes for the image, originally created for Client A, whose use has been purchased.

(7-5-4-3) An End-User is able to access and view the resold image, which has been integrated into Client B's website according to the system owner's instructions, and appears to the end-user as if it is sourced from Client B's website.

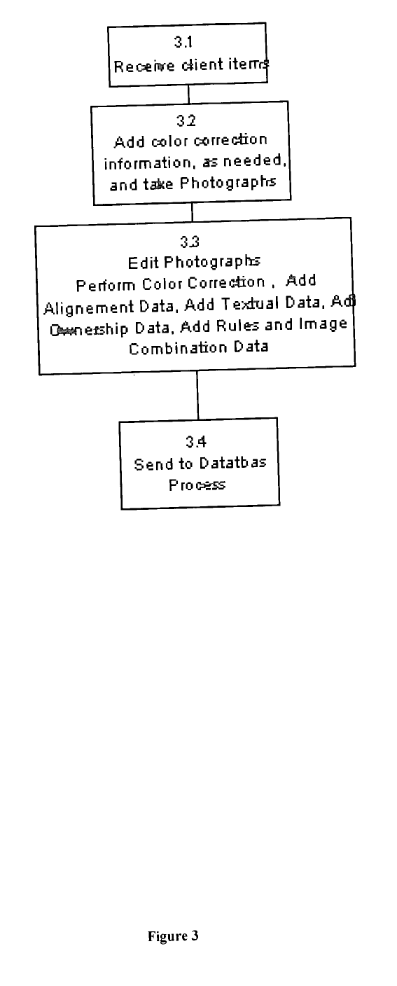

FIG. 3 is a high-level flow chart illustrating the workflow of the present invention for the general process of photography, the addition of data and generalized color-correction. This flow chart also describes the invention's general process of adding photographs to the database. Items are received from the client in block 3.1. Color correction data is added to these items, if needed, and the items are then photographed, usually, but not always digitally, (in block 3.2). The photos are then edited (in block 3.3), color-corrected, and alignment, textual, ownership, rules, and combination limitation data are added. Then (in block 3.4) the digital photographs are sent to the database process.

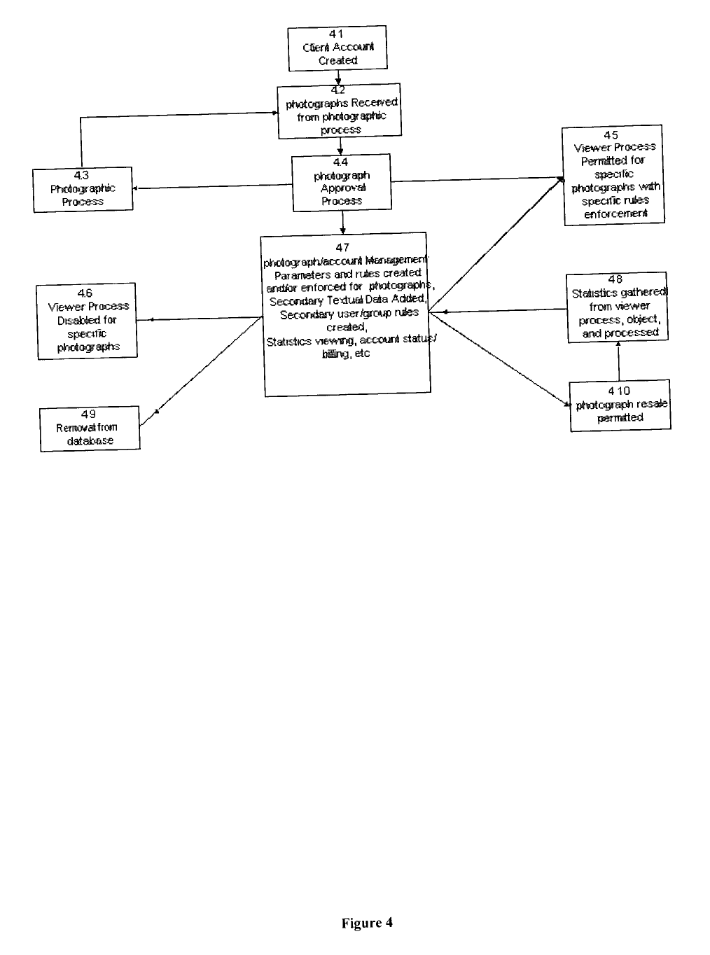

FIG. 4 is a high-level flow chart describing the invention's general process of database operation, including a representation of the basic digital photograph management process, and account management. In block 4.1 the client's database account is created, and then (in block 4.2) digital photographs are received from the photographic process. Next, clients can approve or disapprove their use of digital photographs (block 4.4). If digital photographs are disapproved, the photographic process can begin again and digital photographs are again retuned to the database process for approval. If approved, viewing of digital photographs may be permitted at this time, as depicted by viewer process object (block 4.5) and/or digital photograph management can be conducted in block 4.7. In block 4.7, clients and/or the invention owner manage accounts and digital photographs. Among other things, these parties can set parameters and rules for digital photographs and the database, which will be enforced by the database and/or the viewing software. They can add and/or select textual data for display with digital photographs, or in the viewer process, they can create and manage user/group accounts and policies, view statistics, account information, billing, and many other types and portions of information. From block 4.7, clients can also affect and/or enable the viewer process shown in block 4.5. Block 4.8 depicts statistics being gathered and processed for digital photographs flowing through block 4.5. If in block 4.7, digital photograph resale (shown in block 4.10, and defined as the ability for other specific clients, or groups of clients to buy digital photographs for re-use in the system) is enabled, statistical data may also be sent to block 4.8. Clients can also stop approved digital photographs from being viewed (block 4.6), or remove digital photographs from the database (block 4.9).

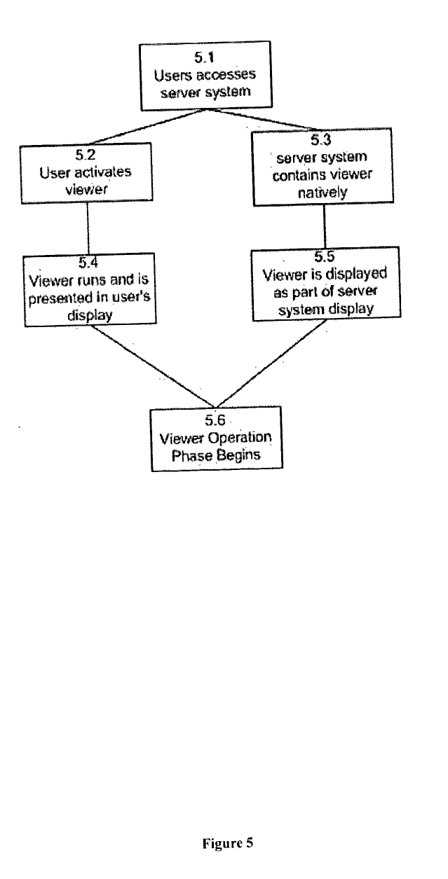

FIG. 5 is a general flow chart describing how a user could invoke an instance, or instances, of the viewer, from, or in, one or more websites, or server systems. In block 5.1, a user browses, or in some other way accesses a website or server system which has permission to connect to this invention's database object. In block 5.2, the user invokes the viewer object by clicking on a link, digital photograph, text, or by committing some other action. The viewer object may also be directly integrated with the website or server system, so that no action is needed on the part of the user to invoke the viewer object (block 5.3). Note that it is possible to invoke multiple instances of the viewer object. Furthermore, it is also possible that invocation actions committed after the first invocation of the viewer may not invoke a new instance of the viewer object, but instead may interoperate with and/or relate to the initially invoked instance of the viewer object. If the viewer is invoked, and is not integrated directly with the website or server system, the viewer is loaded and subsequently displayed on the user's system (block 5.4). In block 5.5, the viewer begins operation by indicating what, if any, item the user was interested in when the viewer was invoked. This indication may (or may not) be made by the display of a small digital photograph in the viewer object. Note that if the viewer is integrated directly with the website or server system, it may be pre-configured with a set, or sets of item digital photographs.

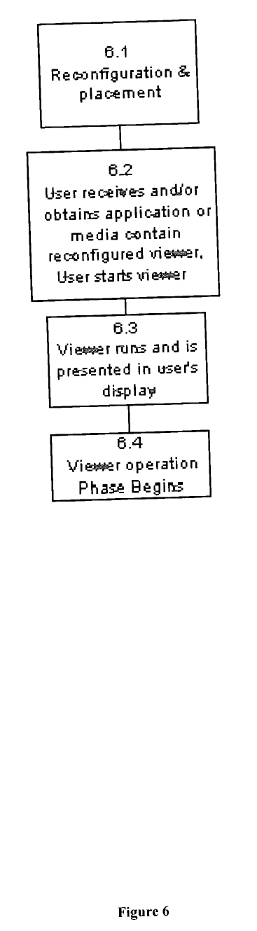

FIG. 6 is a flow chart describing how a user could invoke an instance, or instances, of the viewer, from, a referring application, or media, including, but not limited to when the viewer contains a pre-selected and/or pre-configured set of item digital photographs. In block 6.1, a set, or sets, of digital photographs are configured, possibly in some combination, by the client, using tools that are part of the current invention. These sets are placed into an instance of the viewer, which is, in turn, placed in a host system, which may include, but not be limited to electronic mail applications, other applications and/or storage media including, but not limited to, Compact Discs. In block 6.2 the user loads the application or media storing the viewer object, which in turn may load and present the viewer object on the user's display (block 6.3). Loading the viewer object can be automatic, or manual based on user action. In block 6.4, the viewer begins operation by indicating what, if any, items were pre-configured. This indication may (or may not) be made by the display of a small digital photograph in the viewer object.

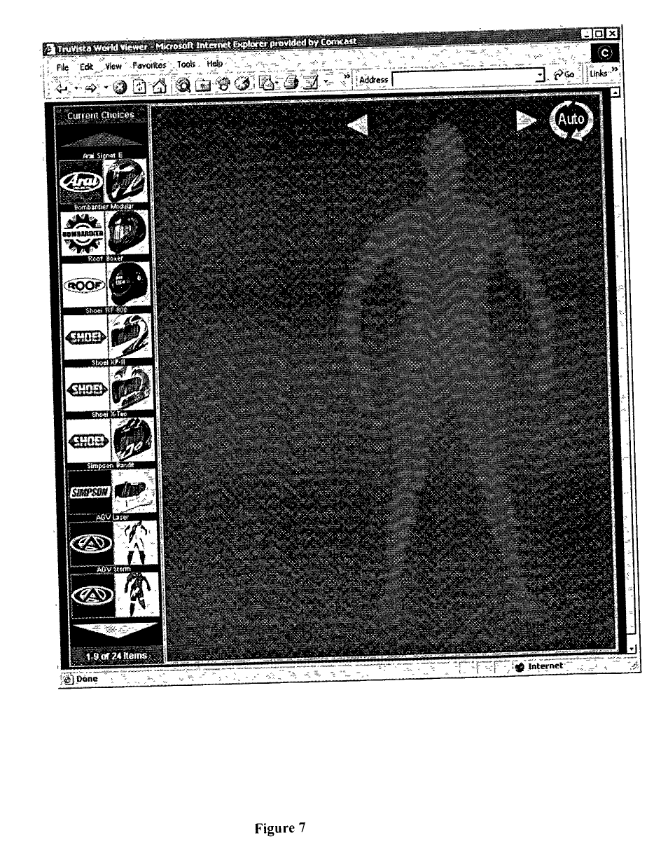

FIG. 7 a sample computer screen shot of the system's viewer object, as it might appear after invocation in as per FIG. 5 or FIG. 6, and from, or in, one or more websites, or server systems.

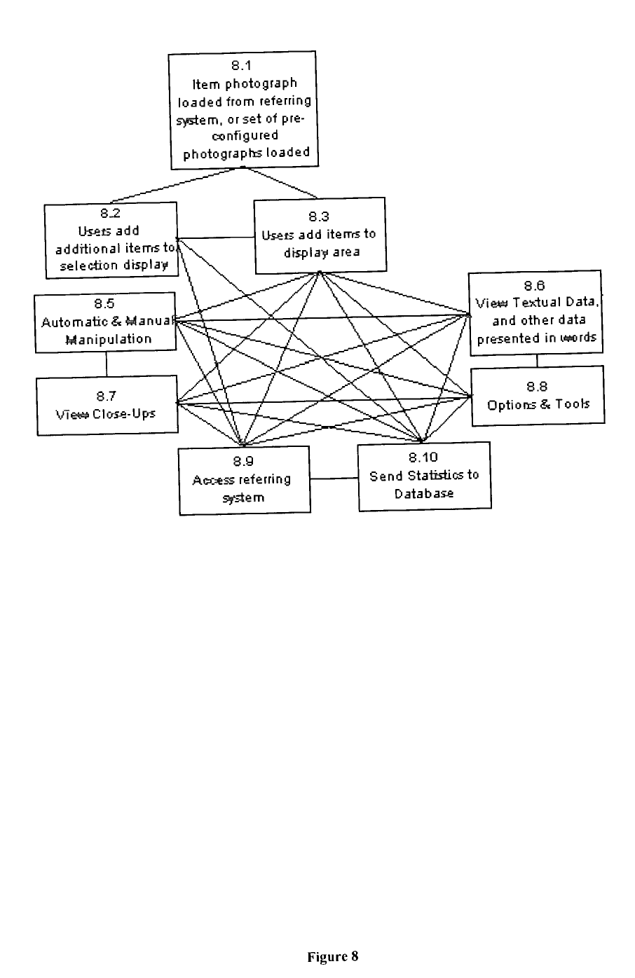

FIG. 8 is a flow chart describing the operation of the invention's viewer object, its function, and operation. In block 8.1 the viewer invocation process completes, and the viewer is displayed on the user's system or in a server system. At this point, the viewer may contain one or more digital photographs and/or references, indicating the items the user was interested in and/or the items that the user can take further action with in the viewer object. The user can then load additional items into the viewer object (block 8.2), and indications of this action will again be made in the viewer by one or more digital photographs and/or references, in order to take actions with those items in subsequent steps. Note that a potentially unlimited number of digital photographs and/or references can be made/shown in the viewer object. Furthermore, additional items can be loaded at any time in the viewer process. In parallel with, or after block 8.1, the user can take actions that will prompt the viewer object to show digital photographs in greater detail (represented in block 8.3). The digital photographs can be shown individually, combined with other digital photographs, separated, removed, or in other ways, depending on actions taken in block 8.3. The acts of adding, combining, and separating digital photographs can be performed at anytime, and in combination with block 8.2, and all subsequent blocks and actions. From this point, another series of actions can be taken. These actions include, but are not limited to automatic or manual digital photograph manipulation, with one or more digital photographs, potentially in combination (block 8.5), viewing descriptive or other types of textual data in the system (block 8.6), the viewing of close up/detail digital photographs from the system (block 8.7), and the modification of options, including, but not limited to backgrounds, digital photograph sizing, coloration, themes, information specificity level, color calibration and more. Additionally, block 8.4, represents that users can access other systems, including, but not limited to, websites, server systems, and/or purchasing systems. Block 8.10 depicts that the viewer object can send statistics related to many user actions to this invention's object database system Note that user actions in the viewer process are not mutually exclusive, and taking these actions can be performed at anytime after block 8.2, and in any combination.

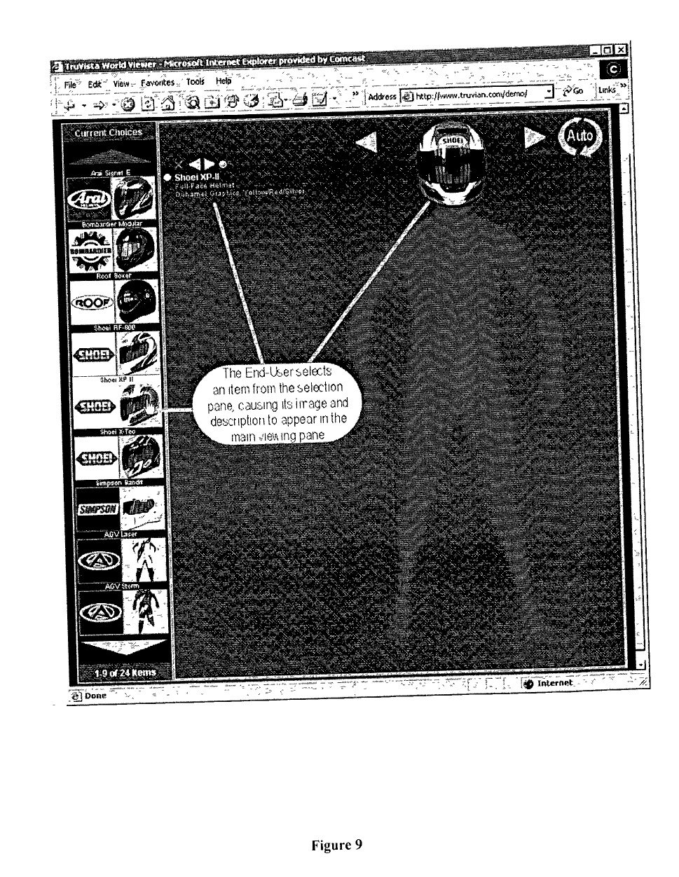

FIG. 9 is a computer screen shot illustrating the implementation of the present invention as it would be viewed on the end-user's computer screen. This particular figure illustrates how the end user would choose different types of apparel for display on the computer screen. In this particular embodiment, the items being chosen for display are motorcycle apparel. In the FIG. 9, the first item chosen is the helmet. The user would use the computer mouse or other pointing device to select the particular helmet from the choices displayed on the left column of the screen. The chosen helmet will then be represented on what would be the head of the person in the main viewing area.

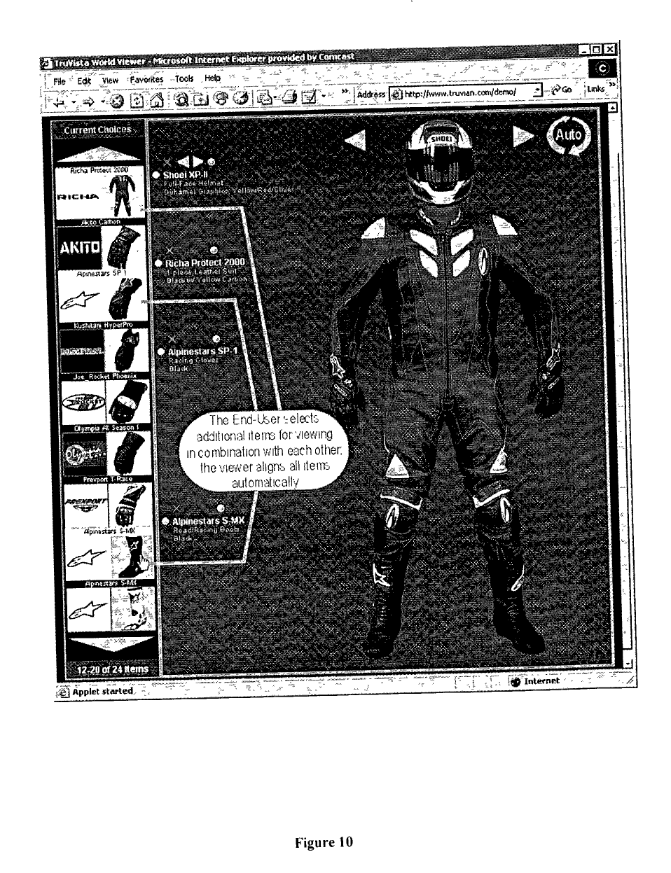

FIG. 10 is another computer screen shot illustrating what will be shown in the main viewing area after additional items of motorcycle apparel are chosen for display. In FIG. 10, the helmet has been combined with gloves, boots and a body suit to illustrate how the various items would appear in combination to an end user. The mixing and matching of various items, possibly from different manufacturers, is an advantage over presently available systems or methods since it allows for a virtually unlimited combination of various items. In this way, the end user can see a computer representation of what he or she may actually look like if the items are actually purchased.

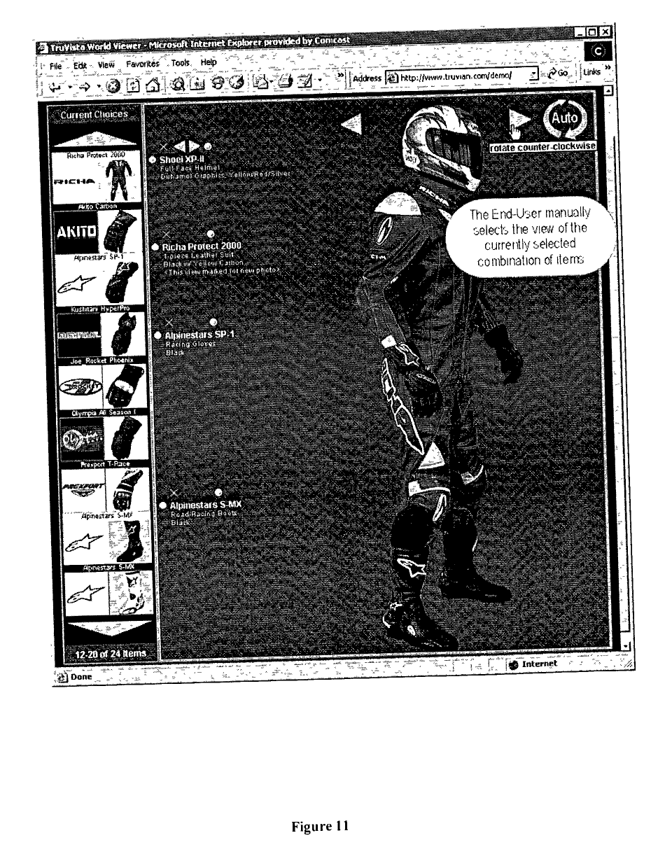

FIG. 11 Is another computer screen shot illustrating how the end user can manipulate the image after combining several items of apparel. In FIG. 11, the image is rotated so that the user can view the combined items of apparel from different perspectives.

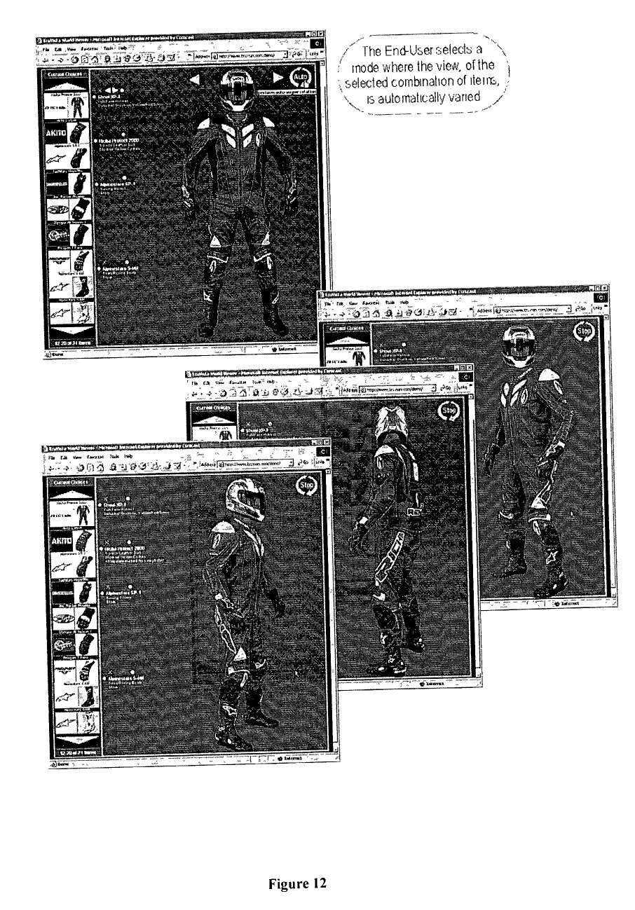

FIG. 12 is a series of computer shots illustrating the process of automatically manipulating and combining item digital photographs an example rendition of the viewer object.

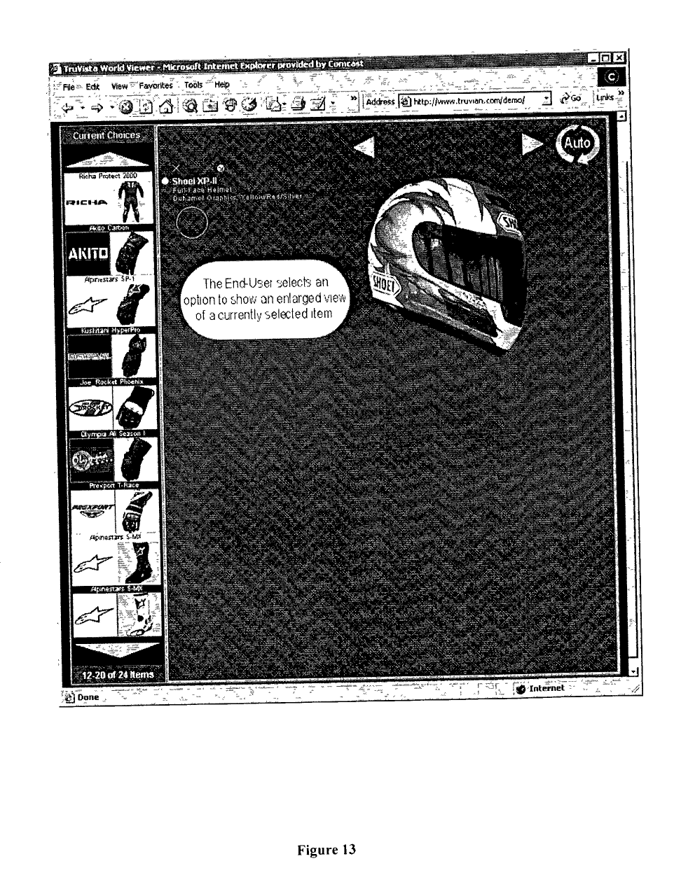

FIG. 13 is a computer screen shot illustrating the process of showing an enlarged version digital photograph of an item in an example rendition of the viewer object.

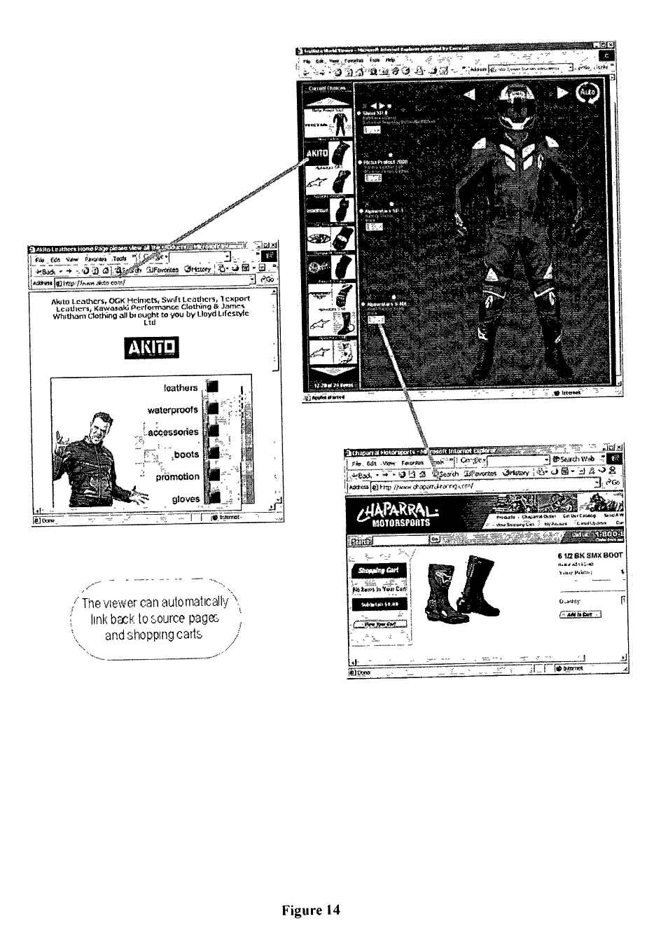

FIG. 14 is a series of computer shots illustrating how items in the viewer object could refer users to, or interoperate with, a purchasing system, or information, from or in a web site, or server system outside of the present invention.

Those of ordinary skill in the art will recognize that the embodiments just described merely illustrate the principles of the present invention. Many modifications may be made thereto without departing from the spirit and scope of the invention as set forth in the following claims.

What is claimed is:

1. A method for electronically presenting, combining and manipulating digital photographs, comprising the following steps:
a) Producing specialized digital photographs, of a plurality of objects or items on behalf of one or more item suppliers, from one or more angles;
b) Adding descriptive pieces of information for each of the plurality of items, including, but not limited to scaling, descriptive text, and alignment data;
c) Adjusting relational and/or absolute digital photograph coloration;
d) Storing the digital photographs in an electronic system;
e) Invoking software, contained in a plurality of web sites, a plurality of server systems, any type of digital storage medium, an electronic application, or some combination thereof that permits a plurality of users to select one or more digital photographs from a plurality, or set, of digital photographs in the system or provide a pre-defined set of digital photographs;
f) Displaying the digital photographs on a computer display; and
g) Permitting the digital photographs to be mixed, matched, combined, separated, and manipulated, from multiple viewing angles, multiple volumetric dimensions, and in multiple virtual scenarios, either manually or automatically.

2. A method as in claim 1 where various pieces of information are stored with each digital photograph, thereby permitting any number of rules to be enforced by the system in order to control the presentation, manipulation and combination of digital photographs.

3. A method as in claim 1 where digital photograph positioning is done automatically by specifying one or more named alignment points for each digital photograph, specified in terms of each individual digital photograph, not the display device space.

4. A method as in claim 1 where scale information is stored with each digital photograph, permitting a user and/or the system to adjust digital photograph size to in order to enforce correct relational visual size proportion.

5. A method as in claim 1, 3 or 4 where background digital photographs can be varied to give a user a sense of context in relation to product digital photographs.

6. A method as in claim 1 where the system can maintain multiple views of each item, and where the system includes associated information about the particular view of each item.

7. A method as in claim 1 where the display of combinations of product digital photographs can continue through multiple angles and views, and where sets of product digital photographs remain related and combined even though viewing angles and relation to the user may change.

8. A method as in claim 1 where textual information can be stored and/or presented visually or otherwise, in relation to each item, along with coordinate points that specify what area of the digital photograph is relevant to each description.

9. A method as in claim 1 where more detailed digital photographs can be stored and/or presented, using positioning data stored by the system, in relation to various parts of less detailed digital photographs.

10. A method as in claim 5 where the background digital photograph could be assigned spatial information that defines scale, in combination with position, aspect, angle and spacing of item digital photographs and/or sets of combined digital photographs as a function of position within the background digital photograph so that realistic multidimensional virtual spaces can be constructed, thereby permitting digital photographs to be displayed within the space with proper visual digital photograph scale.

11. A method as in claim 1 where product digital photograph compatibility and access to the system can be controlled using file format and naming convention enforcement, and/or authentication and/or encryption technology.

12. A method as in claim 1 where the system can function independently of any specific web site or server system, or one or more of such sites and systems, thereby maintaining the user's “session” and/or “state information”.

13. A method as in claim 12 where items that are correlated to different entities or owners can be displayed and/or manipulated together in combination or individually in one or more electronic spaces in and one or more electronic display systems thereby allowing a user to display and combine items sold by different entities in a single display.

14. A method as in claim 1 where the system can maintain information for digital photographs in order to relate digital photographs to their source so that a user is enabled to refer to server systems or purchasing systems from a plurality of entities.

15. A method as in claim 1 where the system can implement special manual or automatic display capabilities for digital photographs to enhance the functionality of the system, including, but not limited to, simulated rotation of combined sets of digital photographs, the movement of component digital photographs the movement of parts of digital photographs (as opposed to entire digital photographs), the movement of sets of combined digital photographs, simulated shadow casting, and variations in the virtual light source, light intensity, coloration, pattern, effect, and, consistency.

16. A method as in claim 1 where the system, or parts of the system can be placed on storage media, inside systems, applications, or other software, in order to deliver pre-configured combinations of digital photographs and/or alternative digital photographs.

17. A method as in claim 1 where the system can automatically collect data pertaining to what digital photographs have been or are being viewed, for what duration, with what manipulation, and in combination with other digital photographs.

18. A method as in claim 16 where digital photograph data, source data, and statistical data can be correlated between multiple websites, server systems, organizations, or entities.

19. A method as in claim 1 where digital photograph data, source data, and statistical data can be correlated between multiple websites, server systems, organizations, or entities.

20. A method as in claim 1 where the system can automatically sort and compile data into useful statistics.

21. A method where administrative sub-ownership data can be correlated with digital photographs in a system that contains a plurality of digital photographs in order to assign sets of administrative rights for digital photographs or groups of digital photographs to users or groups of users, for the purpose of implementing controlled access to photographs and functions.

22. A method as in claim 21 where digital photograph owners can select descriptive data from a set of data types and variables in order to display data in relation to displayed digital photographs.

23. A method as in 1 wherein access to the system can be limited based on authentication and authorization technologies.

24. A method as in claim 1 where digital photographs and the ability to display them in relation to certain web sites or server systems can be brokered and/or resold between authorized customers and/or users of the system.

25. A method as in claim 1 where digital photographs can be very high quality and density, and will possibly not pixilate when being viewed.

26. A method as in claim 1 where digital photograph coloration is adjusted to match both a set of absolute values and a set of relational color specifications.

27. A method as in claim 1 where the components of the system permit users to color calibrate their displays, either manually or automatically to match the system's color calibrations.

28. A method as in claim 7 where the system permits individual items which are part of a combination to be changed at any time during manipulation and or rotation.

29. A method as in claim 24 where the system can automatically collect data pertaining to what digital photographs have been or are being viewed, for what duration, with what manipulation, and in combination with which other digital photographs for an entire chain of clients and photograph buyers.

30. A method as in claim 1 where the system can intake and then display information specified by users, including, but not limited to commentary, and reference lists.
